(19) United States
(12) Patent Application Publication
(10) Pub. No.: US 2006/0187905 A1
(43) Pub. Date: Aug. 24, 2006

(54) Communication method, communication system, and bridge device

(75) Inventor: Masao Manabe, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/322,424

(22) Filed: Jan. 3, 2006

(30) Foreign Application Priority Data
Feb. 7, 2005 (JP) 2005-030287

(51) Int. Cl. H04L 12/56

(52) U.S. Cl. 370/352; 370/401; 370/310

(57) ABSTRACT

A communication system according to an embodiment of the present invention includes: a wireless host performing a master operation; a wired/wireless bridge device communicating with the wireless host via a radio link; and a plurality of devices connected with the wired/wireless bridge device via a wired link and performing a slave operation to communicate with the wireless host via the wired/wireless bridge device, the wired/wireless bridge device controlling transfer with the plurality of devices in accordance with a communication bandwidth of the radio link.

### BACKGROUND OF THE INVENTION

1. Field of the Invention

The present invention relates to a communication method, a communication system, and a wired/wireless bridge device, which are used for transferring data between a wireless host and a device through two transmission paths, a wired transmission path and a wireless transmission path.

2. Description of Related Art

Nowadays, the USB (Universal Serial Bus) has been widely used in place of existing external interfaces for personal computers, for example, legacy ports such as serial ports and parallel ports. The USB1.x standard supports two bus transmission speeds, 1.5 Mbit/s as a low speed and 12 Mbit/s as a full speed, and is adopted for PC peripheral devices connected via a bus that allows data transmission at a relatively low speed. In recent years, a variety of peripheral devices conforming to the USB2.0 standard that supports a bus transmission speed of 480 Mbit/s have been developed and commercialized.

The foregoing USB enables connection up to 127 devices to a bus by expanding a port using a HUB. Further, in the USB, only one device serves as a host, and the host functions as abus master. The USB network topology is a star network topology where the host is positioned at the center, the HUBs are arranged at each branch point of a bus, and the USB device is connected at the terminal.

Further, in the USB, the host communicates with each USB device by time-division multiplexing through scheduling. The USB standard defines the following four data transfer types.

(1) Controlled transfer: nonperiodic communication mainly supporting the plug and play use of a host. This transmission is not suitable for high-speed or full-speed data transfer but is used for controlling devices in combination with another transmission type.

(2) Bulk transfer: nonperiodic communication used for transferring a large amount of data without care about transmission delay.

(3) Interrupt transfer: communication between a host and devices which is performed by a host executing periodically polling, and is used for exchanging information about a low-frequency event between the host and devices in an asynchronous fashion.

(4) Isochronous transfer: continuous and periodic communication, more specifically, transfer of streaming data requiring real-time reproduction such as moving pictures and audio data.

There are almost no time constraints on nonperiodic transfer types (1) and (2), but severe time constraints are imposed on the types (3) and (4); the constraints are such that a transfer processing should be completed within a predetermined time period. To that end, the USB2.0 standard allows the use of up to 90% of a communication bandwidth based on the isochronous transfer upon the full-speed transfer. Further, upon the high-speed transfer, up to 80% of communication bandwidth is available to the isochronous transfer. The host precisely determines the number of devices involved in the isochronous transfer and whether or not another transfer type can be adopted in a free band thereof to control the transfer and also decides whether or not a device additionally connected with a USB network can be supported.

Further, the host schedules transactions as the unit of communications with devices. As for the USB1.x standard, one frame has a period of 1 ms, and is generated using plural transactions. On the other hand, in a high-speed (480 Mbit/s) mode of the USB2.0 standard, transactions are scheduled based on a so-called micro-frame with a frame period of 125 μs.

A USB cable includes four lines in total, two data lines as a twisted-pair line, a power supply line, and a GND line. Automatic power supply from the host to the device through the USB cable and automatic flow control are executed when the device is connected with the host.

However, in the case of connecting between the host, the HUB, and the devices, there arises a problem in that positions of the devices cannot be freely changed. A request to freely change the positions of the devices when in use is increasing in parallel with the shift to the ubiquitous society.

To meet such a request, Japanese Patent Translation Publication No. 2003-508952 discloses a technique for freeing peripheral devices from constraints of the USB cable by connecting the PC with the HUB by radio, and connecting the HUB with the peripheral devices such as a mouse and a scanner using the USB cable or the like.

Referring to FIG. 1, the conventional technique disclosed in Japanese Patent Translation Publication No. 2003-508952 is described. Reference numeral 811 denotes a processing unit constituting a main computer 81, and communicating with an input unit 82 using an infrared wireless LAN or a radio link 85 such as a radio frequency link. A communication protocol HUB 83 enables communications with plural peripheral devices such as a scanner 841, a joystick 842, and a mouse 843 via an appropriate communication protocol. The main computer 81 communicates with the input unit 82 using the radio link 85, and the communication protocol HUB 83 communicates with the peripheral devices using a USB cable 86 or radio link, so the positional constraints on the input unit 82 and the communication protocol HUB 83 can be considerably eased.

The technique disclosed in Japanese Patent Translation Publication No. 2003-508952 gives no consideration to a fluctuation of a wireless communication bandwidth. However, in the wireless communication, the communication bandwidth is more likely to change due to noises, obstacles, or movement of the device itself. For example, also in the case of using a LAN conforming to the IEEE802.11 standard which has been frequently used as a wireless LAN in recent years for a radio link, the above problem may arise. Further, in the case of using the radio link such as UWB (Ultra Wide Band) that varies a communication bandwidth depending on the distance, the change of the bandwidth more frequently occurs. A conventional problem about the USB-HUB is described below in detail.

If the radio link 85 is the UWB, the communication bandwidth of the UWB significantly varies depending on a distance between the main computer 81 and the input unit 82, that is, a distance between the main computer 81 and the communication protocol HUB 83 in the case of integrating the input unit 82 with the communication protocol HUB 83.

If someone or an obstacle crosses over a path between the main computer 81 and the input unit 82 although not limited to the UWB as the radio link 85, the communication bandwidth is temporarily and remarkably narrowed.

Further, in the case where the plural radio links 85 are provided to execute the wireless communications between the main computer 81 and an input unit (not shown), the communication bandwidth allocated to the radio link 85 of FIG. 1 is reduced. That is, if the communication bandwidth for wireless communications between the main computer 81 and input units is shared among the devices, the communication bandwidth between the input unit and the main computer 81 significantly varies depending on the number of input units sharing the communication bandwidth, the number of devices finally connected with the input units, and a communication bandwidth required by devices.

Further, in the case where the plural input units 82 are provided to execute simultaneous communications between the main computer 81 and the input units, the radio links of the plural input units interfere with one another. In the result, an effective communication bandwidth between the main computer 81 and the input unit 82 becomes narrow.

If the radio link is expanded by using the UWB or the like, the communication bandwidth significantly varies due to various conditions. Next, a detailed description is made of a problem involved in data transfer in the case of varying the communication bandwidth. In the following explanation, the case where the maximum UWB communication bandwidth is 480 Mbit/s and actual communication bandwidth is less than 200 Mbit/s is assumed and considered.

An IN transaction from the peripheral device 84 to the main computer 81 is considered. Although the UWB communication bandwidth is less than 200 Mbit/s, when the communication protocol HUB 83 receives IN packets from the peripheral device 84 at the maximum communication bandwidth of the UWB, 480 Mbit/s, the input unit 82 cannot transfer the IN packets to the main computer 81, and a buffer memory (not shown in FIG. 1) in the communication protocol HUB 83 or the input unit 82 to store the IN packets suffers an overflow.

As a result, there arises a problem in that a large quantity of IN packets that are transmitted from the peripheral device 84 in response to a request from the main computer 81 is discarded on the communication path. At this time, if the IN packets are transferred based on the interruption transfer, isochronous transfer, or other such periodic transfer types, a fatal risk that the transmission of the image data or sound data is interrupted is incurred. In addition, when the IN packets are nonperiodically transferred, a transmission trouble occurs as a consequence of the delay of data transfer timing.

Next, an OUT transaction from the main computer 81 to the peripheral device 84 is considered. Although the communication bandwidth of the UWB is only 200 Mbit/s, if the communication protocol HUB 83 sends the OUT packets to the peripheral device 84 with the maximum communication bandwidth of the UWB, 480 Mbit/s, the OUT data is not sent from the main computer 81 at 480 Mbit/s, so a buffer memory (not shown in FIG. 1)in the communication protocol HUB 83 or the input unit 82 to store the OUT packets suffers an underflow.

As a result, there arises a problem in that the OUT packets that are sent toward the peripheral device 84 in response to a request from the main computer 81 cannot reach the peripheral device 84 at an appropriate timing. At this time, if the OUT packets are sent based on a periodic transfer type, the peripheral device 84 cannot execute a normal processing. In addition, when the OUT packets are nonperiodically transferred, a transmission trouble occurs as a consequence of the delay of data transfer timing.

In the above description, the communication bandwidth of the UWB is 480 Mbit/s at the maximum, and the actual communication bandwidth is only 200 Mbit/s. Even if the communication system is configured such that the UWB is designed with the maximum value of 200 Mbit/s, which is smaller than 480 Mbit/s of the USB2.0 standard, it is impossible to insure the threshold value, 200 Mbit/s, so a problem similar to the above one occurs.

Further, if the maximum value of the communication bandwidth of the UWB is set to, for example, a value as small as 50 Mbit/s, the transfer efficiency of the entire communication system drops.

As mentioned above, in the conventional USB-HUB such as the USB-HUB connected with a host via a radio link as disclosed in Japanese Patent Translation Publication No. 2003-508952, there is no consideration to the fluctuation of the wireless communication bandwidth at the time of controlling the communications with devices.

### SUMMARY OF THE INVENTION

The invention disclosed in this application is schematically implemented as follows in order to solve the above problems.

A communication system according to an aspect of the present invention includes: a wireless host performing a master operation; a wired/wireless bridge device communicating with the wireless host via a radio link; and a plurality of devices connected with the wired/wireless bridge device via a wired link and performing a slave operation to communicate with the wireless host via the wired/wireless bridge device, the wired/wireless bridge device controlling transfer with the plurality of devices depending on a communication bandwidth of the radio link.

According to the communication system of the present invention, it is possible to monitor the communication bandwidth for the communication between the wireless host and the wired/wireless bridge device to control OUT transactions from the wireless host or IN transactions from the devices to the wireless host with reference to the communication bandwidth of the radio link.

Further, according to another aspect of the present invention, there is provided a communication method for a communication system including: a wireless host performing a master operation; a wired/wireless bridge device communicating with the wireless host via a radio link; and a plurality of devices connected with the wired/wireless bridge device via a wired link and performing a slave operation to communicate with the wireless host via the wired/wireless bridge device. The communication method includes: detecting that an additional device is connected to the wired/wireless bridge device; deriving a communication bandwidth of the radio link necessary for communication between all the devices including the additional device and the wired/wireless bridge device; determining whether or not communication with all the devices connected with the wired/wireless bridge device can be performed with the communication bandwidth of the radio link allocated by the wireless host; and requesting the wireless host to increase a communication bandwidth of the radio link to be allocated if it is determined that the communication with all the devices cannot be performed. The detecting, the deriving, the determining, and the requesting are executed by the wired/wireless bridge device.

According to the communication method of the present invention, it is possible to monitor the communication bandwidth for the communication between the wireless host and the wired/wireless bridge device to control OUT transactions from the wireless host or IN transactions from the devices to the wireless host with reference to the communication bandwidth of the radio link. Further, it is possible to request the change of the communication bandwidth of the radio link depending on the number of connected devices, enabling an efficient transfer between the wired/wireless bridge device and the devices. Hence, a packet loss or packet transfer delay can be minimized. It is possible to prevent such a situation that in the case of transmitting the periodic packets of the moving pictures or audio data that requires the real-time reproduction, the transmission of the moving pictures or the audio data is interrupted.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing a conventional communication system;

FIG. 2 is a block diagram showing a communication system according to an embodiment of the present invention;

FIG. 3 illustrates frame control in a communication method according to the present invention;

FIG. 4 illustrates an example of the frame control in the communication method according to the present invention;

FIG. 5 is a flowchart illustrating the communication method according to the present invention;

FIG. 6 is a flowchart illustrating the communication method according to the present invention;

FIG. 7 is a flowchart illustrating the communication method according to the present invention; and

FIG. 8 illustrates a protocol architecture used in the communication method and communication system according to the present invention.

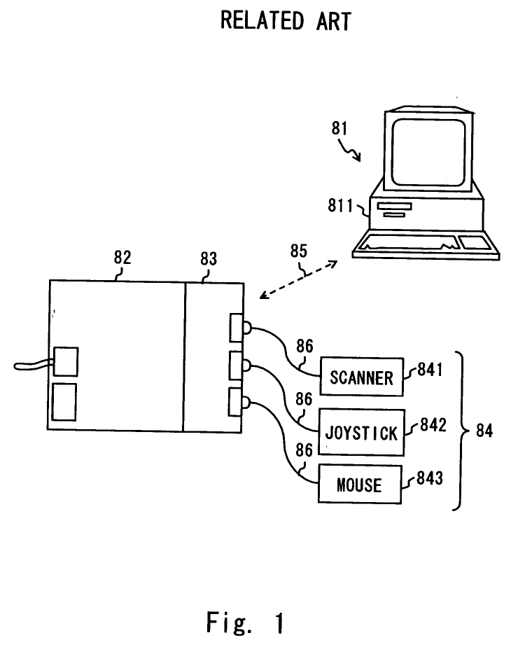

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A communication system according to a first modification of the present invention is structured as follows. The communication system according to the present invention includes: a wireless host performing a master operation; and a plurality of devices performing a slave operation to communicate with the wireless host. The communication system of the present invention further includes a wired/wireless bridge device that is connected with the wireless host via a radio link, and connected with the plurality of devices via a wired link, and relays communication data between the wireless host and the plurality of devices. The wired/wireless bridge device controls transfer with the plurality of devices in accordance with a communication bandwidth of the radio link. More specifically, the wired/wireless bridge device includes a wireless communication unit transmitting/receiving packet data to/from the wireless host via the radio link; and a wired communication unit transmitting/receiving packet data to/from the plurality of devices via the wired link. If a communication bandwidth of the radio link allocated by the wireless host is below a threshold bandwidth that is set based on a transmission/reception amount of the packet data with the plurality of devices, it is preferable that the wired communication unit executes at least one of: (1) control for selectively stopping transfer of periodic packet data to be periodically transferred with the devices, (2) control for limiting transfer nonperiodic packet data to be non-periodically transferred with the devices, and (3) control for requesting the wireless host to increase a communication bandwidth of the radio link.

Further, a communication system according to a second modification of the present invention includes, similar to the first modification, a wireless host, a plurality of devices, and a wired/wireless bridge device. The wired/wireless bridge device executes the following operations. First of all, information about communication between the wireless host and the plurality of devices is monitored to determine whether or not a time interval when the number of transfer errors between the wireless host and the plurality of devices exceeds a threshold value continues for a predetermined period or more. Next, if it is determined that the time interval continues for the predetermined period or more, the wired/wireless bridge device executes at least one of: (1) selectively stopping transfer of periodic packet data to be periodically transferred with the devices; (2) limiting transfer nonperiodic packet data to be non-periodically transferred with the devices; and (3) requesting the wireless host to increase a communication bandwidth of the radio link.

A communication system according to embodiments of the present invention is described below in detail.

### First Embodiment

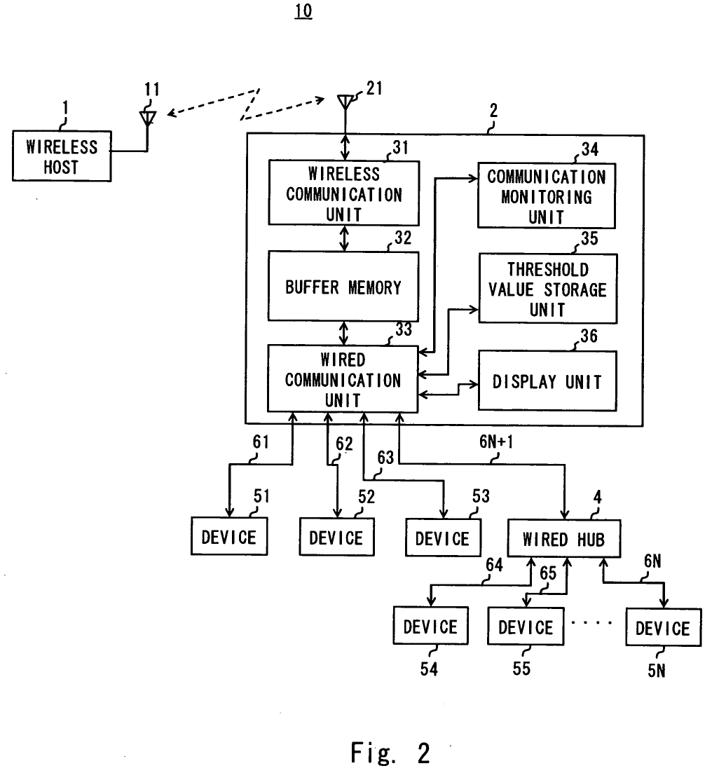

FIG. 2 shows the configuration of a communication system according to a first embodiment of the present invention. A communication system 10 of this embodiment includes a wireless host 1, a wired/wireless bridge device 2, a wired HUB 4, and devices 51 to 5N (N is an integer of 6 or more). The wireless host 1 receives/transmits data from/to the wired/wireless bridge device 2 via an antenna 11. The wireless host 1 is typified by a PC. The wired/wireless bridge device 2 communicates with the wireless host 1 via the antenna 21, and communicates with the devices 51 to 53 via USB cables 61 to 63. The wired HUB 4 is connected with the wired/wireless bridge device 2 via the USB cables 6N+1 to expand a port of the wired/wireless bridge device 2. The devise 54 to 5N are connected with the wired HUB 4 via the USB cables 64 to 6N.

The devices 51 to 5N are typified by peripheral devices such as a mouse, a keyboard, a printer, an image scanner, and a data recorder.

A wireless communication unit 31 of the wired/wireless bridge device 2 amplifies a signal which is sent to the wireless host 1 and outputs the amplified signal to the antenna 21, and in addition, amplifies a signal received from the antenna 21 and outputs the amplified signal as OUT data to a buffer memory 32 with a predetermined time interval T as a unit time. The buffer memory 32 stores the OUT data output from the wireless communication unit 31, and stores IN data which is transmitted to the wireless host 1 during the predetermined time interval T as the unit time.

A wired communication unit 33 reads the OUT data stored in the buffer memory 32 with a USB frame period (125 μs at high speeds) shorter than the predetermined time interval T, and transfers the OUT data to the devices 51 to 53 or the wired HUB 4. Further, the wired communication unit 33 outputs the IN data transferred from the devices 51 to 53 and the wired HUB 4 to the buffer memory 32 with the USB frame period.

The wired/wireless bridge device 2 of the present invention further includes a communication monitoring unit 34 and a threshold value storage unit 35. The communication monitoring unit 34 monitors communication states between the wireless host 1 and the devices 51 to 5N, and outputs the monitoring result to the wired communication unit 33. The threshold value storage unit 35 stores a threshold value such as an allowable value of the communication bandwidth.

The communication monitoring unit 34 monitors the following parameters as mentioned below.

1) The number of times the IN data from the devices 51 to 5N is discarded on the communication path

2) The number of packet errors of the OUT data sent from the wireless host 1

3) The number of failures in transmission of the OUT data to the devices 51 to 5N within a predetermined period

4) The number of packets transmitted/received between the wireless host 1 and the wireless communication unit 31

An allowable value of the communication bandwidth stored in the threshold value storage unit 35 is a value of a communication bandwidth necessary for the radio link between the wireless host 1 and the wired/wireless bridge device 2. It is desirable that the allowable value be dynamically set by the wired/wireless bridge device 2 based on the number of devices connected with the wired/wireless bridge device 2, the bandwidth necessary for periodic packet transfer, the bandwidth for nonperiodic packet transfer, and the bandwidth for monitoring. Incidentally, the allowable value may be a fixed value previously stored in the wired/wireless bridge device 2.

Further, a display unit 36 displays a message for a user based on such as characters, graphics and LED on/off patterns.

In the communication system 10, the wireless host 1 is a single master device. The wireless host 1 executed polling of the devices 51 to 5N to allow each of the devices 51 to 5N to transfer data as a result of the polling.

Next, a description is given of the basic operation of the IN transaction in the case where a sufficient communication bandwidth is ensured in the radio link between the wireless host 1 and the wired/wireless bridge device 2 and the normal transfer is executed.

The wireless host 1 executes the polling of the devices 51 to 5N, and the devices 51 to 5N output IN data as a result of the polling when the data is stored in an end point buffer (not shown) incorporated in devices 51 to 5N. When no data is stored in the end point buffer, the devices send NAK signals.

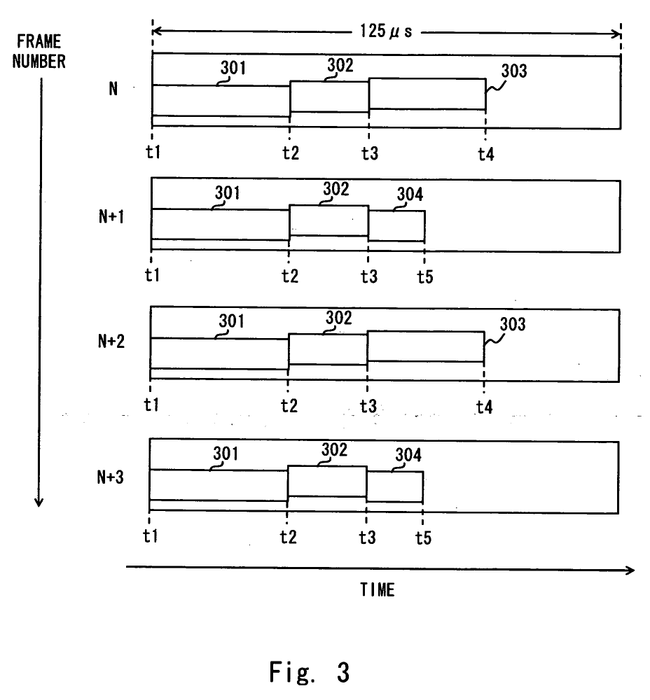

Referring to FIG. 3, a detailed description thereof is given. FIG. 3 shows a control method for the frames N to N+3 composed of periodic packet data 301 to 304 and nonperiodic packet data. The horizontal and vertical axes both indicate time axis. Incidentally, the periodic packet data implies data transferred through interrupt transfer or isochronous transfer out of the foregoing USB transfer types. Further, the nonperiodic packet data is data transferred through controlled transfer or bulk transfer.

The frames N to N+3 are micro-frames with a frame period of 125 μs. Among those, the frames N and N+2 are composed of the periodic packet data 301 to 303 and nonperiodic data (not shown). The periodic packet data 301 to 303 are arranged between a time t1 and a time t2, between t2 and t3, and between t3 and t4, respectively. The nonperiodic packet data is arranged from the time t4 onward. On the other hand, the frames N+1 and N+3 are composed of the periodic packet data 301, 302, and 304, and nonperiodic packet data (not shown). The periodic packet data 301, 302, and 304 are arranged between the time t1 and the time t2, between t2 and t3, and between t3 and t5, respectively. The nonperiodic packet data is arranged from the time t5 onward.

The periodic packet data 301 and 302 are transferred every frame, and the periodic packet data 303 and 304 are transferred every two frames. The periodic packet data 301 to 304 preferentially constitute the micro frame, and the nonperiodic packet data is arranged in the remaining portion of the micro frame. Such packet scheduling is executed by the wired communication unit 33.

The wired communication unit 33 executes the scheduling as shown in FIG. 3 to receive the frames N to N+3 from the devices 54 to 5N and store the received packet data in the buffer memory 32 in order.

The wireless communication unit 31 reads and reconfigures the micro frames stored in the buffer memory 32 into data based on the predetermined time interval T. The read data is subjected to analog modulation and then output to the antenna 21. The wireless host 1 demodulates a signal input through an antenna 11, and stores the demodulated signal as IN data in a memory built in the wireless host 1. The same processing is applied to the OUT data as well, but its description is omitted here.

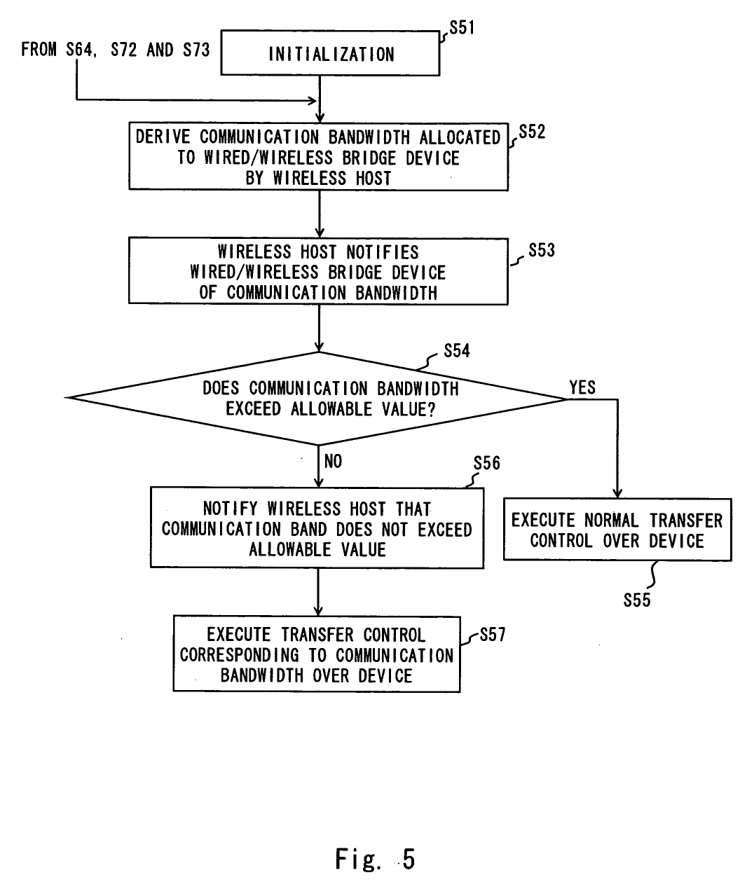

Referring next to FIGS. 2 and 5, a description is given of an operation performed when the communication bandwidth of the radio link is not enough. First, in step S51, the wired/wireless bridge device 2 of the present invention is initialized, and then the buffer memory 32 is initialized, the threshold value stored in the threshold value storage unit 35 is sent to the wired communication unit 33, and the configuration necessary for the connection between the wired/wireless bridge device 2 and the devices 51 to 5N, and between the wired/wireless bridge device 2 and the wireless host 1 is set. Hence, the wired communication unit 33 can recognize the states of the connected devices 51 to 5N.

In the initialization of the wired/wireless bridge device 2 in step S51, an allowable value of the communication bandwidth is determined, and the determined allowable value is stored in the threshold value storage unit 35 as the threshold value. The way to determine the allowable value is as follows. For example, when the wired/wireless bridge device 2 is connected with the devices 54 to 5N, the wired/wireless bridge device 2 obtains descriptor information stored in the devices 54 to 5N, and grasps whether a device requiring a periodic transfer such as interrupt transfer or isochronous transfer is provided, and a transfer rate requested by the device, and then the wired/wireless bridge device 2 calculates the allowable value based on these.

Next, in step S52, the communication bandwidth that is allocated to the wired/wireless bridge device 2 by the wireless host 1 is calculated. The wireless host 1 communicates with the wired/wireless bridge device 2 based on protocol architecture shown in FIG. 8. As shown in FIG. 8, the communication bandwidth of the UWB as a physical layer is shared among applications 1 to M such as TCP/IP in a time-division manner. A MAC (Media Access Control) layer executes control so as to allow these applications 1 to M to share the communication bandwidth of the UWB in a time-division manner. The wireless host 1 references the share of the communication bandwidth among the applications 1 to M executed with the wired/wireless bridge device 2, and the number of wireless devices communicating with the other wireless host omitted from FIG. 2 to calculate a communication bandwidth allocated to the wired/wireless bridge device 2.

Next, in step S53 of FIG. 5, information about the communication bandwidth calculated in step S52 is sent from the wireless host 1 to the wired/wireless bridge device 2. In step S54, the wired communication unit 33 references the allowable value read from the threshold value storage unit 35 to determine whether or not the communication bandwidth notified by the wireless host 1 exceeds the allowable value.

If the wired communication unit 33 determines that the communication bandwidth notified by the wireless host 1 exceeds the allowable value, that is, if the communication bandwidth of the radio link is enough, in step S55, the wired/wireless bridge device 2 executes normal transfer control over the devices 51 to 5N. On the other hand, if it is determined that the communication bandwidth notified by the wireless host 1 does not exceed the allowable value, that is, if the communication bandwidth of the radio link is not enough, in step S56, the wired/wireless bridge device 2 notifies the wireless host 1 that the communication bandwidth is below the allowable value. Subsequently, in step S57, the wired/wireless bridge device 2 executes transfer control over the devices 51 to 5N corresponding to the allocated communication bandwidth.

Next, a specific example of a method of controlling transfer corresponding to the communication bandwidth is described. A first method is such that the wired/wireless bridge device 2 requests the wireless host 1 to increase the allocated communication bandwidth. If the wireless host 1 can afford to allocate additional bandwidth, the wireless host 1 allocates more communication bandwidth to the wired/wireless bridge device 2 that sent a request to increase the communication bandwidth. As a result, the wireless host 1 can stably communicate with the devices 51 to 5N using a requisite communication bandwidth.

Next, a second method of controlling transfer corresponding to the communication bandwidth is described. The second method controls a transfer amount of the nonperiodic packet data to be transferred from the time t4 onward or from the time t5 onward as shown in FIG. 3. Further, if a radio-wave transmission state becomes worse, and the allocated communication bandwidth is temporarily below the allowable value, the transfer of nonperiodic packet data may be temporarily suspended. Thus, the transfer of the periodic packet data can be prioritized. With this method, the transfer of the nonperiodic packet data is delayed. However, time constraints are not originally imposed on the nonperiodic packet data, so even if the transfer of the nonperiodic packet data is delayed, neither packet loss nor an error in data transfer between the wireless host 1 and the devices 51 to 5N occur.

Reducing the transfer amount of the nonperiodic packet data or stopping the transfer of the nonperiodic packet brings increasing a time area where the periodic packet data 301 to 304 can be arranged within one frame period (125 μs). Thus, a possibility for arranging the periodic packet data 301 to 304 within one frame period increases, so even if the communication bandwidth of the radio link falls below the allowable value set by the wired/wireless bridge device 2, the wired/wireless bridge device 2 can stably transfer the periodic packet data 301 to 304.

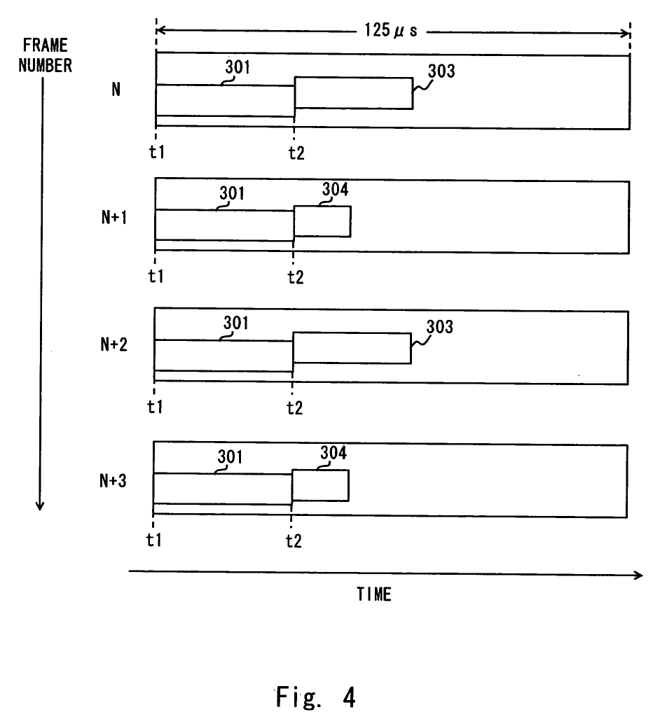

Further, a third method of controlling transfer corresponding to a communication bandwidth for communications between the wired/wireless bridge device 2 and each of the devices 51 to 5N is described. FIG. 4 shows the case where upon the frame control as shown in FIG. 3, the transfer of the periodic packet data 302 is stopped. For example, if the periodic packet data 302 is data transferred between the device 52 of FIG. 2 and the wired/wireless bridge device 2, the transfer between the wired/wireless bridge device 2 and the device 52 is stopped. The wired/wireless bridge device 2 displays a message to the effect that the communication with the device 52 is stopped because of an insufficient communication bandwidth, on a display portion (not shown) of the device 52, the display unit 36 of the wired/wireless bridge device 2, or a display device not shown in FIG. 2.

As described above, when the communication bandwidth of the radio link is narrowed, and the communication bandwidth of the radio link is below the allowable value stored in the threshold value storage unit 35, the wired/wireless bridge device 2 selectively stops the data transfer with some of the devices 51 to 5N so as not to cause a ripple effect on the hole devices 51 to 5N connected with the wired/wireless bridge device 2.

With this method, although the transfer with some of the devices is stopped, the communication with the rest can be continued. A communication state of the communication system 10 becomes stable in this case rather than the case of continuously executing the communication between all the devices 51 to 5N and the wired/wireless bridge device 2. Therefore, this method is effective for when the communication bandwidth notified by the wireless host 1 is still insufficient although the transfer of the nonperiodic packet data is restricted or stopped based on the second method.

Any one of the first to third methods may be selected and executed, but the first to third methods may be combined and executed. For example, the wired/wireless bridge device 2 desirably executes the first method to request the wireless host 1 to allocate more communication bandwidth, and executes the second method until the communication bandwidth is increased to prioritize the transfer of the periodic packet data or executes the third method to stop the communication with a specific device. Further, if the wireless host 1 increases the communication bandwidth, the second method and the third method are not executed. Hence, the communication state of the overall system can be kept stable even while the wireless host 1 increases the communication bandwidth.

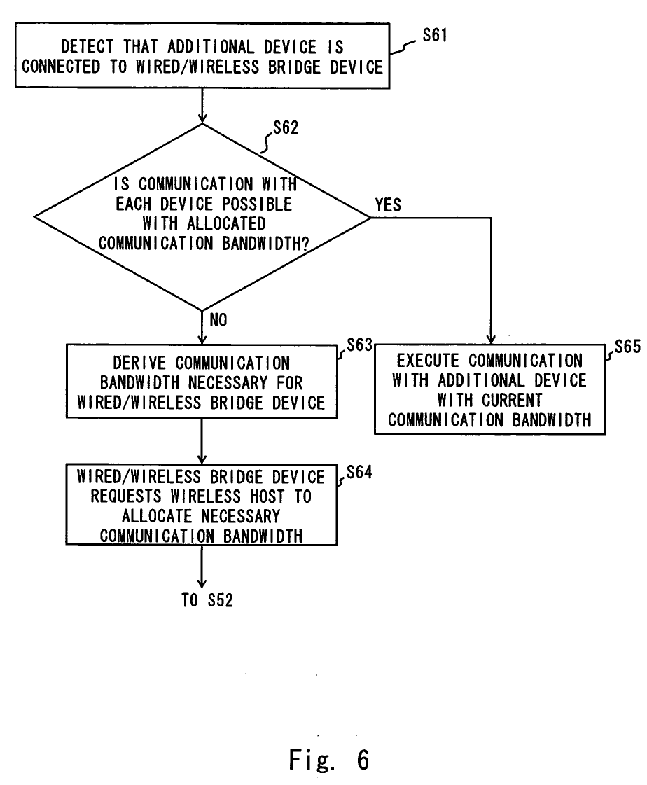

Referring next to FIG. 6, a communication method executed when an additional device is connected with the wired/wireless bridge device 2 is described. If in step S61, the wireless host 1 detects that an additional device 5N+1 is connected with the wired/wireless bridge device 2, in step S62, the wired/wireless bridge device 2 determines whether or not the communication with each of the devices 51 to 5N+1 can be performed with the communication bandwidth allocated by the wireless host 1. If the communication can be performed with the communication bandwidth allocated by the wireless host 1, the processing is shifted to step S65, and the wired/wireless bridge device 2 communicates with the existing devices 51 to 5N and the additional device 5N+1 with the current communication bandwidth.

Next, in step S62, if the wired/wireless bridge device 2 cannot communicate with the devices 51 to 5N+1 with the current allocated communication bandwidth, the processing is shifted to step S63, and the wired/wireless bridge device 2 calculates the communication bandwidth necessary for the packet data transfer between the wired/wireless bridge device 2 and all the connected devices including the additional device.

Next, in step S64, the wired/wireless bridge device 2 requests the wireless host 1 to allocate the communication bandwidth derived in step S64, after which step S52 of FIG. 5 and subsequent steps are executed. The above description is directed to the case where one device 5N+1 is added, but the same applies to the case where plural devise are concurrently added.

### Second Embodiment

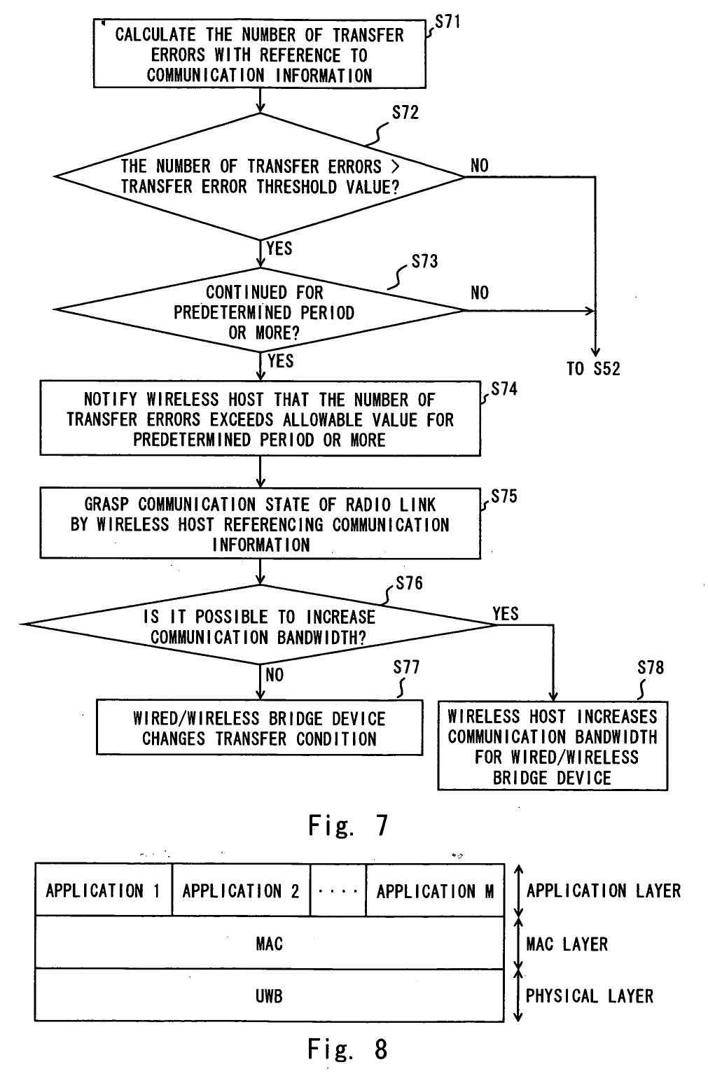

A communication system according to a second embodiment of the present invention is described. The configuration of the communication system of this embodiment is the same as the communication system 10 of FIG. 2, so the configuration is described if desired with reference to FIG. 2. FIG. 7 shows a control flow for controlling the communication bandwidth with the communication system of this embodiment. In step S71, the wired communication unit 33 calculates the number of transfer errors with reference to the communication information stored in the communication monitoring unit 34 that monitors the communication between the wireless host 1 and each of the devices 51 to 5N. Here, the communication information includes the foregoing parameters as listed below.

1) The number of times the IN data from the devices 51 to 5N is discarded on the communication path

2) The number of packet errors of the OUT data sent from the wireless host 1

3) The number of failures in transmission of the OUT data to the devices 51 to 5N within a predetermined period

4) The number of packets transmitted/received between the wireless host 1 and the wireless communication unit 31

Next, in step S72, the wired communication unit 33 determines whether or not the number of transfer errors calculated in step S71 is larger than a transfer error threshold value stored in the threshold value storage unit 35. If it is determined that the number of transfer errors is smaller than the transfer error threshold value, step S52 of FIG. 5 and subsequent steps are executed.

On the other hand, if it is determined that the number of transfer errors is larger than the transfer error threshold value in step S72, in step S73, the wired communication unit 33 determines whether or not a time interval when the number of transfer errors exceeds the transfer error threshold value continues over a predetermined period. Here, if it is determined that the time interval when the number of transfer errors exceeds the transfer error threshold value is shorter than the predetermined period, step S52 of FIG. 5 and subsequent steps are executed. If it is determined that the time interval when the number of transfer errors exceeds the transfer error threshold value continues over the predetermined period, in step S74, the wired/wireless bridge device 2 sends a message that the number of transfer errors exceeds the transfer error threshold value for a predetermined period or more to the wireless host 1, and sends the corresponding communication information.

Next, in step S75, the wireless host 1 references the communication information sent from the wired/wireless bridge device 2 to grasp the communication state of the radio link. Further, in step S76, the wireless host 1 determines whether or not the communication bandwidth for the wired/wireless bridge device 2 that detects consecutive occurrences of transfer errors can be increased based on the communication state grasped in step S75. If the communication bandwidth can be increased, in step S78, the communication bandwidth for the wired/wireless bridge device 2 is increased.

On the other hand, if it is determined that the communication bandwidth cannot be increased, in step S77, the transfer conditions are changed to execute the transfer method explained in step S57 of FIG. 5.

To be specific, as described above, the wired/wireless bridge device 2 selectively stops the packet data transfer with some of the devices 51 to 5N so as not to cause a ripple effect on the devices 51 to 5N connected with the wired/wireless bridge device 2. Then, a message that transfer errors consecutively occurs for a predetermined period and a message that the transfer with some of the devise is selectively stopped are displayed on a display portion of the device (not shown), on the display unit 36 of the wired/wireless bridge device 2, or on a display device not shown in FIG. 2. The display of the messages gives advice about how to improve the communication state to a user since the wireless communication error may result from inadequate layout of the device.

Incidentally, not only displaying the messages mentioned above, but the current state of the communication bandwidth between the wireless host 1 and the wired/wireless bridge device 2, and the current share of the communication bandwidth may be displayed in addition to the messages described above. Those information can be derived by the wired communication unit 33 based on a parameter such as the number of transmitted/received packets between the wireless host 1 and the wireless communication unit 31 which is monitored by the communication monitoring unit 34, and the communication bandwidth allocated by the wireless host 1. Further, it is possible to display a message to the effect that the communication state of the radio link can be improved by positioning the wired/wireless bridge device 2 in another position.

It is apparent that the present invention is not limited to the above embodiment that may be modified and changed without departing from the scope and spirit of the invention.

What is claimed is:

1. A communication system, comprising:
a wireless host performing a master operation;
a wired/wireless bridge device communicating with the wireless host via a radio link; and
at least one device connected with the wired/wireless bridge device via a wired link and performing a slave operation to communicate with the wireless host via the wired/wireless bridge device, wherein;
the wired/wireless bridge device controlling transfer with the device depending on a communication bandwidth of the radio link.

2. The communication system according to claim 1, wherein the wired/wireless bridge device determines whether or not the communication bandwidth is below a threshold bandwidth, and notifies the wireless host that the communication bandwidth is below the threshold bandwidth to request the wireless host to increase the communication bandwidth.

3. The communication system according to claim 2, wherein:
the wireless host derives a communication bandwidth to be newly allocated to the wired/wireless bridge device in response to the request, and notifies the wired/wireless bridge device of the newly allocated communication bandwidth, and
the wired/wireless bridge device determines whether the newly allocated communication bandwidth is above or below the threshold bandwidth.

4. The communication system according to claim 1, wherein the wired/wireless bridge device selectively stops transfer of periodic packet data with the device in response to determining that the communication bandwidth falls below a threshold bandwidth.

5. The communication system according to claim 1, wherein the wired/wireless bridge device stops transfer of nonperiodic packet data to be transferred with the device in a nonperiodic manner or reduces a transfer amount of the nonperiodic packet data in response to determining that the communication bandwidth falls below a threshold bandwidth.

6. The communication system according to claim 1, wherein the wired/wireless bridge device requests the wireless host to increase the communication bandwidth in response to determining that the communication bandwidth falls below a threshold bandwidth.

7. The communication system according to claim 1, wherein a physical layer of the radio link is a UWB (Ultra Wide Band), a MAC (Media Access Control) executes time-division control over applications constituting a protocol layer and executed based on a corresponding one of a plurality of protocols, and the communication bandwidth is derived for each of the applications.

8. The communication system according to claim 1, wherein the device is USB device.

9. The communication system according to claim 1, wherein the wired/wireless bridge device includes a buffer memory storing packet data received from the wireless host in a first period and storing packet data transferred from the device in a second period different from the first period.

10. The communication system according to claim 9, wherein the wired/wireless bridge device further includes:
a wireless communication unit amplifying and outputting a signal to be transmitted to the wireless host, and amplifying a signal received from the wireless host to output the amplified signal as OUT data to the buffer memory; and
a wired communication unit scheduling the OUT data stored in the buffer memory and transmitting the OUT data to the device in the second period, and scheduling IN data received from the device and outputting the IN data to the buffer memory in the first period.

11. The communication system according to claim 10, wherein the wired/wireless bridge device includes a communication monitoring unit monitoring a communication state between the wireless host and the device and notifying the wired communication unit of a monitoring result, the wired communication unit controlling a transfer data amount of the device based on the monitoring result.

12. A communication method for a wired/wireless bridge device that is connected with a wireless host performing a master operation via a radio link, and connected with at least one device that performs a slave operation to communicate with the wireless host via a wired link, and relays communication data between the wireless host and the device, the method comprising:
controlling transfer with the device in accordance with a communication bandwidth of the radio link.

13. The communication method according to claim 12, wherein if the communication bandwidth is below a threshold bandwidth, transfer of a plurality of periodic packet data to be periodically transferred with the device is selectively stopped.

14. The communication method according to claim 12, wherein if the communication bandwidth is below a threshold bandwidth, transfer of a plurality of nonperiodic packet data to be non-periodically transferred with the device is stopped or a transfer data amount of the nonperiodic packet data is reduced.

15. The communication method according to claim 12, wherein the controlling includes:
detecting that an additional device is connected to the wired/wireless bridge device;
deriving a communication bandwidth of the radio link necessary for communication between all the devices including the additional device and the wired/wireless bridge device;
determining whether or not communication with all the devices connected with the wired/wireless bridge device can be performed with the communication bandwidth of the radio link allocated by the wireless host; and
requesting the wireless host to increase a communication bandwidth of the radio link to be allocated if it is determined that the communication with all the devices cannot be performed,
the detecting, the deriving, the determining, and the requesting being executed by the wired/wireless bridge device.

16. The communication method according to claim 12, wherein the controlling includes:
monitoring information about communication between the wireless host and the device to determine whether or not a time interval when the number of transfer errors between the wireless host and the device exceeds a threshold value continues for a predetermined period or more; and
executing at least one of: selectively stopping transfer of periodic packet data to be periodically transferred with the device; limiting transfer nonperiodic packet data to be non-periodically transferred with the device; and requesting the wireless host to increase a communication bandwidth of the radio link, if it is determined that the time interval continues for the predetermined period or more,
the monitoring and the executing being performed by the wired/wireless bridge device.

17. The communication method according to claim 16, wherein the information about communication includes at least one of the number of times packet data transmitted from the device is discarded in the middle of transfer, the number of packet errors of packet data received by the wireless host, the number of failures in transmission of packet data to the device, and the number of packets transmitted/received between the wireless host and the wired/wireless bridge device.

18. A wired/wireless bridge device for relaying communication data between a wireless host performing a master operation and at least one device performing a slave operation to communicate with the wireless host, comprising:
a wireless communication unit transmitting/receiving packet data to/from the wireless host via a radio link; and
a wired communication unit transmitting/receiving packet data to/from the device via a wired link, which limits transmission/reception of packet data to/from the device if a communication bandwidth of the radio link is below a threshold bandwidth that is set based on a transmission/reception amount of the packet data with the device.

19. The wired/wireless bridge device according to claim 18, wherein if the communication bandwidth is below the threshold bandwidth, transfer of periodic packet data to be periodically transferred with the device is selectively stopped.

20. The wired/wireless bridge device according to claim 18, wherein if the communication bandwidth is below the predetermined communication bandwidth, transfer of nonperiodic packet data to be non-periodically transferred with the device is limited.

21. The wired/wireless bridge device according to claim 18, further comprising a display unit displaying a message that the communication bandwidth is below the threshold bandwidth.
